(19) United States
(12) Patent Application Publication
(10) Pub. No.: US 2017/0244666 A1
(43) Pub. Date: Aug. 24, 2017

(54) NETWORK CONTROL SYSTEMS, BUILDING CONTROL SYSTEMS, REMOTE COMMUNICATION DEVICES AND METHOD THEREOF

(71) Applicant: Gainsborough Hardware Industries Limited, Blackburn, Victoria (AU)

(72) Inventor: Harris LAMBROU, Blackburn, Victoria (AU)

(73) Assignee: Gainsborough Hardware Industries Limited, Blackburn, Victoria (AU)

(21) Appl. No.: 15/507,031

(22) PCT Filed: Sep. 9, 2015
(86) PCT No.: PCT/AU2015/000552

§ 371 Date: Feb. 27, 2017

(30) Foreign Application Priority Data
Sep. 10, 2014 (AU) 2014903599

(51) Int. Cl. H04L 29/12; H04L 29/08; H04L 12/28

(52) U.S. Cl. CPC H04L 61/2076; H04L 12/2818; H04L 67/025; H04L 61/1511

(57) ABSTRACT

A remote communication device for controlling at least one building control system, the remote communication device comprising a processor arranged to: determine that there is no communication between a remote communication device network address of the remote communication device and a building control system network address of a network communication module in communication with the building control system, and, upon a positive determination, send an electronic communication comprising the remote communication device network address to an electronic communication receiving module accessible by the building control system to enable the building control system to obtain the remote communication device network address for reinitiating communications with the remote communication device wherein each of the remote communication device, network communication module and electronic communication receiving module have different network addresses.

### TECHNICAL FIELD

The present invention relates generally to network control systems, building control systems, remote communication devices and methods thereof.

### BACKGROUND

Building control systems exist whereby remote communication devices (e.g. mobile telephones, tablets and laptops) can communicate with the building control system. These building control systems may be located inside the building they control or located externally and communicate with the devices that are part of the building. Communication is usually via the Internet and enables the remote communication device to control various devices in the building.

One example of a building control system is a security system that can be remotely controlled (i.e. controlled from outside of the building) to activate and de-activate locks and/or doors forming part of the security system. For example, the security system may include physical door locks that can be controlled through activation and de-activation of the security system. Also, the security system may include surveillance and alarm systems. Other types of building control system include utility control systems that enable control of light, heating and cooling systems as well as control of appliances within the home.

In conventional building control systems, in order for a remote communication device (e.g. a mobile telephone) to contact and communicate with the control system, the remote communication device must determine a network address (such as a TCP/IP address) of the control system. This then enables the remote communication device and control system to communicate directly with each other via the Internet using TCP/IP communication protocols.

Where the control system is connected to the Internet via a static IP address, this is easily achievable, as the IP address of the control system never changes. However, many Internet Service Providers (ISPs) do not allow some customers to have a static IP address, or charge a premium for one.

Where the Internet connection of the control system uses a dynamic IP address, the IP addresses of the control system are generally updated and permanently stored in a Dynamic Domain Name System (DDNS), which enables the remote communication device to access the current IP address of the control system by accessing the DDNS database. Although security systems are in place to reduce the risk of unauthorised access to these IP addresses, security breaches do inevitably occur. If the IP addresses of all customers of a security firm are located in a single database, this can result in a huge security breach.

It is possible to enable customers to choose their own DDNS provider in order to spread the load and mitigate any problems associated with a security breach. However, it is not unusual for a large majority of customers to end up choosing the same DDNS provider thus increasing risk from a security breach.

### SUMMARY

It is an object of the present invention to substantially overcome, or at least ameliorate, one or more disadvantages of existing arrangements.

Disclosed are arrangements which seek to address the above problems by removing the requirement to have a central storage facility holding dynamic IP addresses of building control systems.

According to a first aspect of the present disclosure, there is provided a remote communication device for controlling at least one building control system, the remote communication device comprising a processor arranged to: determine that there is no communication between a remote communication device network address of the remote communication device and a building control system network address of a network communication module in communication with the building control system, and, upon a positive determination, send an electronic communication comprising the remote communication device network address to an electronic communication receiving module accessible by the building control system to enable the building control system to obtain the remote communication device network address for reinitiating communications with the remote communication device, wherein each of the remote communication device, network communication module and electronic communication receiving module have different network addresses.

According to a further aspect of the present disclosure, there is provided a remote communication method for controlling at least one building control system, the remote communication method comprising the steps of: determining that there is no communication between a remote communication device network address of the remote communication device and a building control system network address of a network communication module in communication with the building control system, and, upon a positive determination, sending an electronic communication comprising the remote communication device network address to an electronic communication receiving module accessible by the building control system to enable the building control system to obtain the remote communication device network address for reinitiating communications with the remote communication device, wherein each of the remote communication device, network communication module and electronic communication receiving module have different network addresses.

Other aspects of the invention are also disclosed.

### BRIEF DESCRIPTION OF THE DRAWINGS

At least one embodiment of the present invention will now be described with reference to the drawings and appendices, in which:

FIGS. 1A and 1B collectively form a schematic block diagram representation of an electronic device upon which described arrangements can be practised;

FIG. 2 shows a schematic diagram of a network control system according to the present disclosure;

FIG. 3 shows a process follow diagram according to the present disclosure;

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

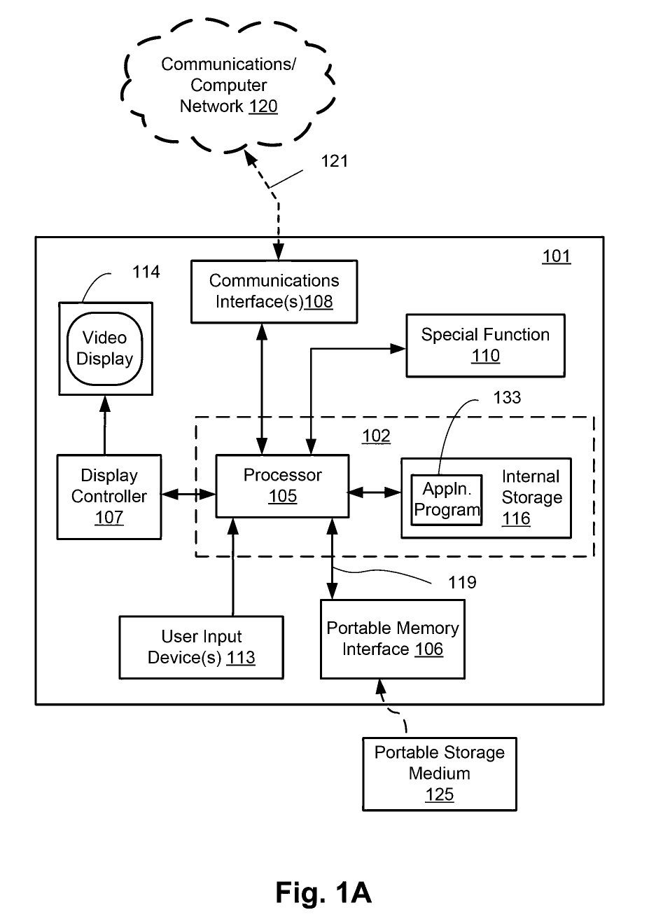

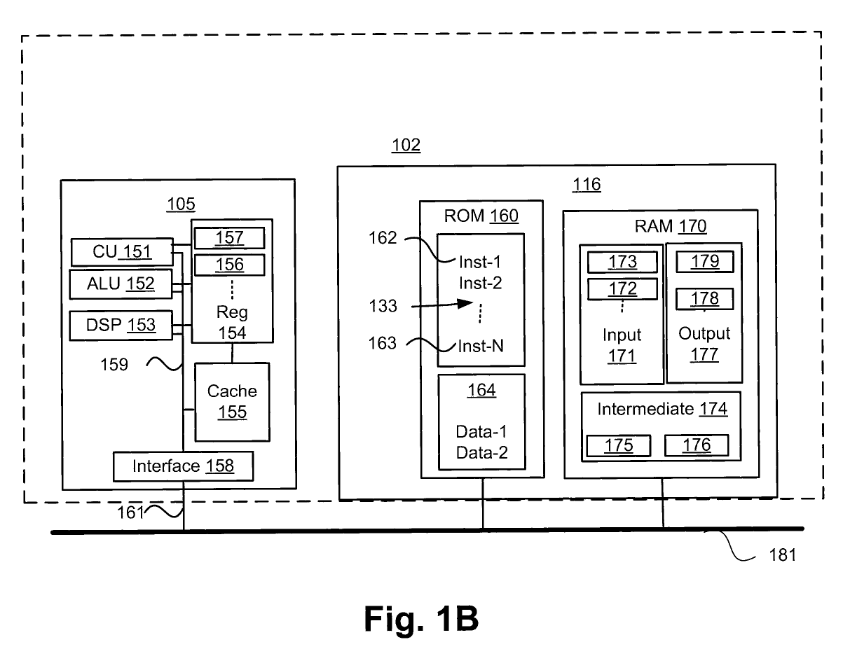

FIGS. 1A and 1B collectively form a schematic block diagram of a general purpose electronic device 101 including embedded components, upon which the herein described communication methods are desirably practiced. The electronic device 101 may be, for example, a mobile phone, a portable media player or a tablet device in which processing resources are limited. Nevertheless, the methods to be described may also be performed on higher-level devices such as desktop computers, server computers, and other such devices with significantly larger processing resources.

As seen in FIG. 1A, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 116. The storage module 116 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 also includes user input devices 113 which are typically formed by keys, a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1A, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 116. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 101 also has a communications interface 108 to permit coupling of the device 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. The special function components 110 are connected to the embedded controller 102. For example, the device 101 may be a mobile telephone handset. In this instance, the components 110 may represent those components required for communications in a cellular telephone environment. Where the device 101 is a portable device, the special function components 110 may represent a number of encoders and decoders of a type including Joint Photographic Experts Group (JPEG), (Moving Picture Experts Group) MPEG, MPEG-1 Audio Layer 3 (MP3), and the like.

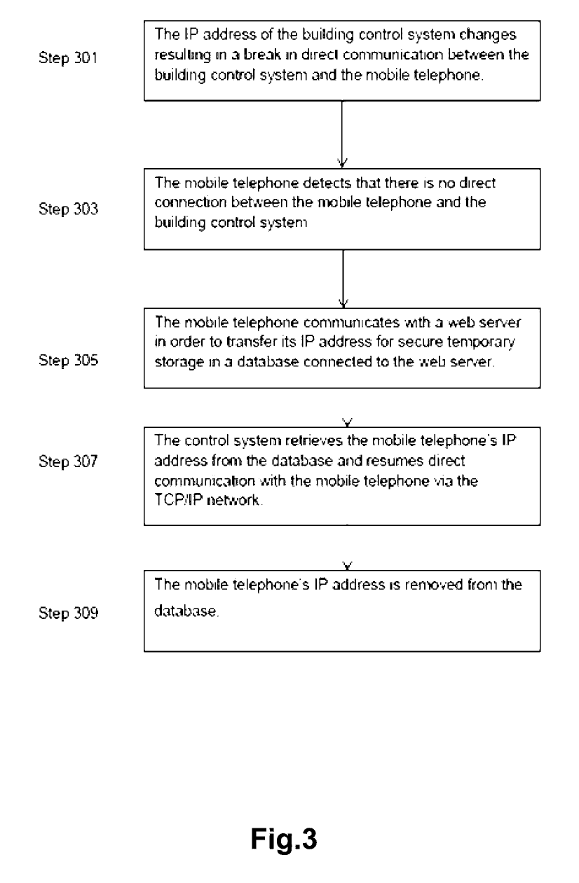

The methods described hereinafter may be implemented using the embedded controller 102, where the processes as described with reference to FIG. 3, may be implemented as one or more software application programs 133 executable within the embedded controller 102. The electronic device 101 of FIG. 1A implements the described methods. In particular, with reference to FIG. 1B, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 116. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 may be pre-installed and stored in the ROM 160 by a manufacturer, prior to distribution of the electronic device 101. However, in some instances, the application program 133 may be supplied to the user encoded on one or more CD-ROM (not shown) and read via the portable memory interface 106 of FIG. 1A prior to storage in the internal storage module 116 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application program 133 and the corresponding code modules mentioned above may be executed to implement one or more graphical user interfaces (GUIs) to be rendered or otherwise represented upon the display 114 of FIG. 1A. Through manipulation of the user input device 113 (e.g., the keypad or touch screen), a user of the device 101 and the application program 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1B illustrates in detail the embedded controller 102 having the processor 105 for executing the application program 133 and the internal storage 116. The internal storage 116 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152, a digital signal processor (DSP) 153 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1A, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

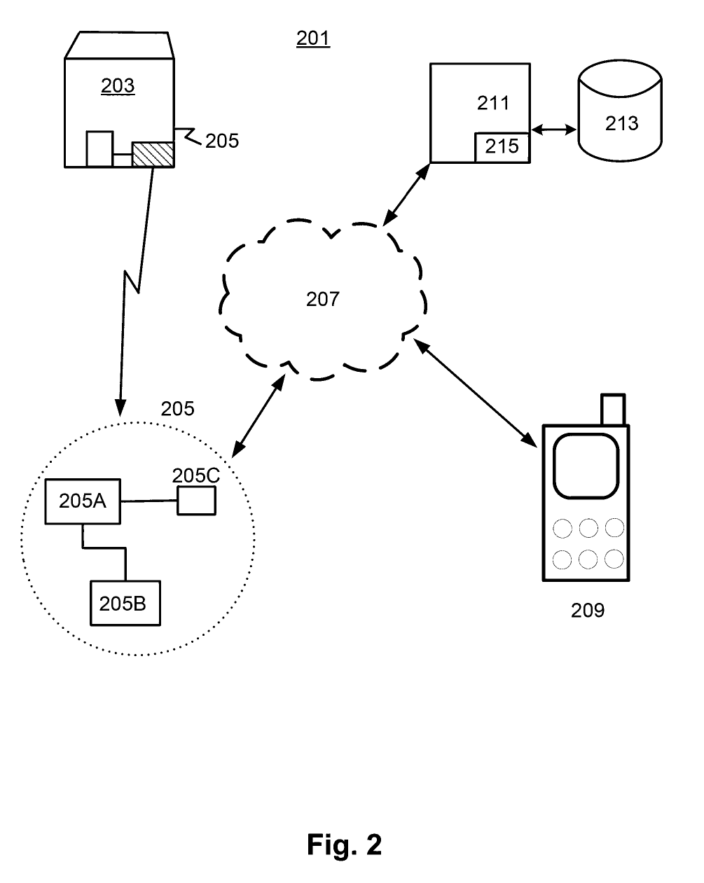

The above described electronic device works remotely from and in conjunction with a building control system as described with reference to FIG. 2 to form a network control system. In each of these examples, the electronic device is described as a mobile communication device, such as a mobile telephone. However, as mentioned above, the device may also be any other suitable electronic device.

According to various examples described below, the network address (e.g. the TCP/IP address) of a network (or IP) communication module of the building control system (e.g. the building control system IP address) is either not stored, or only temporarily stored, in a central database and so significantly reduces the risk of unauthorised access to these IP addresses. Instead, the network address (e.g. the TCP/IP address) of the mobile telephone is made available to an electronic communication receiving module that is accessible by the building control system. This subsequently allows the building control system to make or re-initiate contact with the mobile telephone via the provided network address to enable the building control system and remote device to communicate with each other.

FIG. 2 shows a schematic diagram of a network control system 201.

The network control system 201 is used to control communications between various devices. Within a building 203 is located a building control system 205.

The building control system may be any suitable building control system. For example, the building control system may be a building security system that can be remotely controlled (i.e. controlled from outside of the building) to activate and de-activate locks and/or doors forming part of the security system. This building security system may include physical door locks that can be controlled through activation and de-activation of the security system. The locks may be controlled electronically, electrically or electro-mechanically.

The security system may also include surveillance and alarm systems.

As an alternative, the building control system may be any other suitable type of building control system including, for example, a utility control system that enables control of light, heating and cooling systems within the building. Also, the building control system may enable the control of various devices and/or appliances within the building, such as, for example, washing machines, dryers, dish washers, refrigerators, electronic goods, etc.

According to this example, the building control system 205 has a controller 205A that communicates with a locking system 205B that may be attached a door or window of the building 203. The controller may operate to activate or deactivate the lock dependent upon control signals that are received via an IP communication module 205C. The network (e.g. IP) communication module may be a modem, for example, that is connected to a cellular or wired TCP/IP network 207, such as the Internet. For example, the modem may be connected to a PSTN line, cable network, optical network, cellular network or any other suitable network.

A remote communication device in the form of a mobile telephone 209, for example, is also connected to the TCP/IP network 207. As discussed above, the mobile telephone may be an electronic device as described with reference to FIG. 1A and FIG. 1B and includes software in the form of a software application program.

The software application program (“App”) is stored and executed on the mobile telephone. For example, this App may form part of a larger security access system by which a user controls the security system to gain and stop access to one or more properties. Alternatively, the App may be a standalone App that operates to maintain communications between the mobile telephone and the building control system and operates according to the methods described herein.

A web server 211 is also connected to the TCP/IP network 207 and provides a portal which can communicate with the mobile telephone 209 and building control system 205 via the IP communication module 205C. The web server acts as an electronic communication receiving module for receiving electronic communications over the TCP/IP network. It will be understood from FIG. 2 that each of the web server, the mobile telephone and the IP communication module of the building control system have different IP addresses to each other. The web server also has a database 213 for temporary storage of data. A parser 215 also forms part of the web server.

During normal operation, the App in the mobile telephone is aware of the IP address of the IP communication module and the IP communication module in return is aware of the IP address of the mobile telephone. This enables the mobile telephone and the IP communication module to communicate with each other via the TCP/IP network. This communication may be considered a “direct” communication as routing to devices other than those required to maintain communication is not enabled.

FIG. 3 shows a process for re-initiating communication between the mobile telephone and the building control system as shown in FIG. 2.

At step 301, the network (e.g. TCP/IP) address of the building control system 205 changes. For example, the network (e.g. IP) communication module 205C of the building control system 205 may start communicating via the TCP/IP network 207 using a different IP address to the one previously used due to the IP service provider changing the dynamic IP address associated with the building control system. This results in a break in direct communication between the building control system 205 and the mobile telephone 209 via the TCP/IP network 207.

At step 303, the mobile telephone 209 detects that there is no direct connection between the mobile telephone 209 and the building control system 205 via the TCP/IP network 207.

In this step, the processor in the mobile telephone operates under instructions controlled by the software application program and detects that the mobile telephone is unable to connect with the building control system using the building control system IP address via the TCP/IP network.

At step 305, the mobile telephone 209 communicates with a web server 211 in order to transfer its network (e.g. TCP/IP) address via an electronic message for temporary storage in a database 213 connected to the web server 211. The address of the web server 211 may either be a static address that the mobile telephone is aware of or a dynamic address, which the mobile telephone 209 is able to acquire.

It will be understood that the storage of the electronic message in the database may be made securely such that the message is encrypted using any known suitable techniques. Further, the message may include the last known building control system IP address or mobile telephone IP address.

In this step, the processor in the mobile telephone operates under instructions controlled by the software application program and creates and sends an electronic message from the mobile telephone to the web server. For example, the electronic message may be an HTTP communication sent from the mobile telephone to the web server.

At step 307, the building control system also communicates with the web server 211 to retrieve the mobile telephone's IP address from the database 213 and resumes direct communication with the mobile telephone 209 via the TCP/IP network 207. That is, the building control system 205 contacts the mobile telephone 209 to re-initiate communications.

In this step, the controller 205A of the building control system 205 sends a request via the IP communication module 205C over the TCP/IP network to the web server 211. The request is for the IP address of the mobile telephone that has been stored in the database. In response, the web server retrieves the stored IP address of the mobile telephone and sends it to the building control system controller via the TCP/IP network. The building control system may then resume direct communication with the mobile telephone via the TCP/IP network using the received IP address.

In order for the web server to provide the correct IP address in cases where multiple IP addresses are stored for multiple mobile telephones, the web server may request further information from the building control system. For example, the further information may be an account number that associates the building control system with the mobile telephone. Alternatively, a password may be required in order to associate the stored IP address of the mobile telephone with the building control system.

At step 309, the mobile telephone's IP address is removed from the database 213, For example, the building control system may send a message to the web server that communication between the mobile telephone and building control system has been re-established. Receipt of this message by the web server may cause the web server to delete the mobile telephone's IP address from the database.

According to certain described examples, the mobile telephone processor may detect whether the communication with the building control system has disconnected or failed. In order for communications between the building control system and the mobile telephone to resume after a change in the network (e.g. TCP/IP) address, the mobile telephone processor determines that there is no direct communication with the building control system. It will be understood that this determination could be performed in many different ways.

The software application program on the mobile telephone may execute the following process to enable the processor to determine whether direct communication between the building control system and the mobile telephone has been lost. When trying to connect the mobile telephone to the building control system, the processor under operation of the software application program may detect that communication has failed and activate a trigger. This trigger then causes the mobile telephone to communicate the above described electronic message containing the IP address of the mobile telephone to the electronic communication receiving module.

For example, the processor under operation of the software application program may detect that a communication from the building control system has not been received in a specific amount of time. That is, a timer may be initiated after every successful communication to start a time period in which a communication must be received from the building control system. If the mobile telephone does not receive a signal from the building control system within the defined time period, a trigger is activated.

As a further example, constant polling may occur between the mobile telephone and the building control system to ensure communications between the mobile telephone and building control system are still active. If the mobile telephone detects that a polling signal is not received in return, a trigger is activated.

As a further example, the mobile telephone may attempt to communicate with the building control system and in return obtain a connection error. Receipt of this connection error may then activate a trigger.

In order for communications between the building control system and the mobile telephone to resume after a change in the building control system IP address, the building control system makes a determination that there is no direct communication with the mobile telephone and subsequently accesses the electronic message as described above to obtain the IP address of the mobile telephone.

This determination by the building control system may occur, for example, by the building control system detecting from the modem that the network (e.g. TCP/IP) address has changed. For example, the building control system may access the modem configuration files in order to monitor the IP address being used to connect the building control system to the Internet. Upon detecting that the current IP address is different to a previous IP address, or that there is no communication between the building control system and mobile telephone, a trigger may be activated. Activation of this trigger then causes the building control system to retrieve the electronic message sent by the mobile telephone containing the mobile telephone's IP address.

Alternatively, a notification may be received from the electronic communication receiving module (e.g. the central server) once the electronic communication receiving module receives the above described electronic message from the mobile telephone. This notification may then trigger the building control system to access the electronic communication receiving module in order to identify the IP address of the mobile telephone within the received electronic message.

As a further alternative, any of the examples described above in relation to the mobile telephone determining that communication has failed between the building control system and the mobile telephone may be applied by the building control system. That is, for example, the building control system may detect that a communication from the mobile telephone has not been received in a specific amount of time. For example, a timer may be initiated after every successful communication to start a time period in which a communication must be received from the mobile telephone. If the building control system does not receive a signal from the mobile telephone within the defined time period, a trigger is activated.

As a further example, constant polling may occur between the mobile telephone and the building control system to ensure communications between the mobile telephone and building control system are still active. If the building control system detects that a polling signal is not received in return, a trigger is activated.

As a further example, the building control system may attempt to communicate with the mobile telephone and in return obtain a connection error. Receipt of this connection error may then activate a trigger.

If the mobile telephone network (e.g. TCP/IP) address has not changed but the building control system network (e.g. TCP/IP) address has, the network (e.g. IP) communication module of the building control system may automatically contact the mobile telephone via the known IP address and resume communication by transferring the building control system IP address to the mobile telephone. Similarly, if the building control system IP address has not changed but the mobile telephone IP address has, the mobile telephone may automatically contact the building control system via the known building control system IP address and resume communication by transferring the mobile IP address to the building control system. However, if both the building control system IP address and the mobile telephone IP address have changed then communication between the two must be re-initiated.

According to a further example, the building control system controller determines that the building control system network address (e.g. a TCP/IP address) has changed since the last known connected state. For example, the building control system controller may store the building control system IP address in internal memory after a successful communication with the mobile telephone. Therefore, the last known successful building control system IP address is maintained in memory. The building control system controller may then determine whether the current building control system IP address is the same as the saved building control system IP address (i.e. the last known building control system IP address providing a successful communication between the mobile telephone and the building control system).

Upon the building control system controller detecting that the current building control system IP address is different to the saved IP address (e.g. that the building IP address has changed since the last connected state), the controller is arranged to communicate with the web server to provide an indication to the web server that communications between the mobile telephone and building control system are to be re-initiated. For example, a flag may be activated in the web server by the controller to inform the mobile telephone that the building control system is aware that its IP address has changed. Any other suitable type of indication is also envisaged. For example, the indication may be provided after a determination that a saved IP address has been lost or corrupted, or indeed any other state has occurred that has resulted in a loss of communication between the mobile telephone and the building control system.

Meanwhile, the processor under operation of the application software on the mobile telephone automatically determines that the mobile telephone network address (e.g. TCP/IP address) has changed since the last known connected state. For example, the processor in the mobile telephone may store the mobile telephone IP address in internal memory after a successful communication with the building control system. Therefore, the last known successful mobile telephone IP address is maintained in memory. The processor in the mobile telephone may then determine whether the current mobile telephone IP address is the same as the saved mobile telephone IP address (i.e., the last known mobile telephone IP address providing a successful communication between the mobile telephone and the building control system).

Upon the processor in the mobile telephone detecting that the current mobile telephone IP address is different to the saved IP address (e.g. that the mobile telephone IP address has changed since the last connected state), the mobile telephone under control of the processor is arranged to communicate with the web server and the processor is arranged to determine whether an indication has been provided by the controller to indicate that communications between the mobile telephone and building control system are to be re-initiated has been activated. For example, the mobile telephone may communicate with the web server and determine whether the flag has been activated. The mobile telephone intermittently contacts the web server to determine whether the flag has been activated. For example, the mobile telephone may contact the web server every few seconds or minutes to determine whether the flag has been activated. Further, the mobile telephone may determine that a saved IP address has been lost or corrupted, or indeed any other state has occurred that has resulted in a loss of communication between the mobile telephone and the building control system.

If the processor in the mobile telephone detects that an indication has been provided (e.g. the flag has been activated), it causes the mobile telephone to log into the web server and communicates its current mobile telephone IP address to the web server. It will also be understood that the mobile telephone may also provide additional information to the web server such as an account number that associates the building control system with the mobile telephone. Alternatively, a password may be required in order to associate the stored IP address of the mobile telephone with the building control system. Further, the last known successful mobile telephone IP address may also be provided to the web server.

After leaving the mobile telephone IP address with the server, the processor in the mobile telephone continues to monitor whether the mobile telephone IP address changes again until communication with the building control system is re-established. In this example, in the event that the mobile telephone IP address changes again before communications are re-established, the processor in the mobile telephone detects this and causes the mobile telephone to communicate the latest mobile telephone IP address to the server.

The building control system controller logs into the web server and retrieves or monitors the mobile telephone IP address stored at the server. The building control system controller determines whether the mobile telephone IP address is new (e.g. different to previously connected mobile telephone IP addresses) and if not, continues to retrieve or monitor the mobile telephone IP address stored at the server at pre-determined intervals. The building control system controller intermittently contacts the web server to determine whether the mobile telephone IP address is new. For example, the building control system controller may contact the web server every few seconds or minutes to determine whether the mobile telephone IP address is new.

Upon detecting that the mobile telephone IP address stored at the server is new, the building control system controller attempts to communicate with the mobile telephone using the retrieved mobile telephone IP address. If the building control system controller determines that there is no successful communication with the mobile telephone, it logs back into the web server again to retrieve the mobile telephone IP address (as the mobile telephone IP address may have changed in the interim period). However, if the building control system controller determines that there is successful communication with the mobile telephone, the building control system controller logs back into the website server and requests that the mobile telephone IP address is deleted, and that the indication that communications between the mobile telephone and building control system are to be re-initiated is removed. For example, the flag may be deactivated.

According to yet a further example, the processor under operation of the application software on the mobile telephone automatically determines that the mobile telephone network address (e.g. a TCP/IP address) has changed since the last known connected state, as described in the previous example. Upon the processor in the mobile telephone detecting that the mobile telephone IP address is different to the saved network (e.g. IP) address (i.e. that the mobile telephone IP address has changed since the last connected state), the processor causes the mobile telephone to communicate with the web server and provide an indication that communications between the mobile telephone and building control system can be re-initiated. For example, a flag is activated in the web server to inform the building control system that the mobile telephone is aware that its IP address has changed. Any other suitable type of indication is also envisaged. For example, the indication may be provided after a determination that a saved IP address has been lost or corrupted, or indeed any other state has occurred that has resulted in a loss of communication between the mobile telephone and the building control system.

Meanwhile, as in the previous example, the building control system controller determines that the building control system network address (e.g. TCP/IP address) has changed since the last known connected state. Upon the building control system controller detecting that the current building control system IP address is different to the saved IP address (e.g. that the building control system IP address has changed since the last connected state), the building control system controller is arranged to communicate with the web server and determine whether an indication has been provided. For example, the building control system controller determines whether the flag to indicate that communications between the mobile telephone and building control system can be re-initiated has been activated. That is, the activation of the flag indicates that the mobile telephone is ready to re-establish communications with the building control system. The building control system controller intermittently contacts the web server to determine whether the indication has been provided (e.g. the flag has been activated) after it has determined that communication with the mobile telephone has failed. For example, the building control system controller may contact the web server every few seconds or minutes to determine whether the flag has been activated. Further, the building control system controller may determine that a saved IP address has been lost or corrupted, or indeed any other state has occurred that has resulted in a loss of communication between the mobile telephone and the building control system.

If the building control system controller detects that the indication has been provided (e.g. the flag has been activated), it logs into the web server and communicates its current building control system IP address to the web server. It will also be understood that the building control system may also provide additional information to the web server such as an account number that associates the building control system with the mobile telephone. Alternatively, a password may be required in order to associate the stored IP address of the building control system with the mobile telephone. Further, the last known successful building control system IP address may also be provided to the web server.

The building control system IP address is only temporarily stored by the web server for a predetermined period of time. That is, after a defined period of time, the building control system IP address is securely deleted from the web server. For example, the predefined period of time may be 5 seconds, 10 seconds, 20 seconds, 30 seconds or more. The maximum amount of time the building control system IP address may be stored by the web server may be set to a period of 1 minute, 2 minutes up to 5 minutes for example. After the time has expired, the building control system IP address is automatically deleted from the web server,

Under control of the processor, the mobile telephone logs into the web server and determines whether the building IP address has been temporarily supplied. The mobile telephone intermittently contacts the web server to determine whether the building IP address has been provided. For example, the mobile telephone may contact the web server every few seconds or minutes to determine whether the building IP address has been provided. It will be understood that the delay between successive instances of the mobile telephone contacting the web server to determine whether the building IP address has been provided is selected so that it is less than the time period in which the building control system IP address is temporarily stored by the web server. That is, the storage duration period (e.g. the storage lifetime) of the building control system IP address is chosen to be longer than the time period between each successive contact of the web server by the mobile telephone to determine whether the building IP address has been provided. This is to ensure that the mobile telephone can contact the web server to determine whether the building IP address has been provided and retrieve the building control system IP address within a period when the building control system IP address is available.

Upon determining that the building control system IP address is available, the mobile telephone retrieves the building control system IP address temporarily stored at the server and re-initiates communication with the building control system. The indication (e.g. the flag) is deactivated in the web server and the building control system IP address is deleted.

According to one example, the reconnection process may be initiated by the mobile telephone. According to a further example, the reconnection process may be initiated by the building control system. According to yet a further example, the retrieval of the building control system network address by the mobile telephone may be by way of the mobile telephone reconnecting with the building control system by providing the mobile telephone network address to the building control system. According to yet a further example, the retrieval of the building control system network address by the mobile telephone may be by way of the building control system temporarily providing the building control system network address to the mobile telephone.

### INDUSTRIAL APPLICABILITY

The arrangements described are applicable to the computer and data processing industries and particularly for the building control system industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A remote communication device for controlling at least one building control system, the remote communication device comprising a processor arranged to:
determine that there is no communication between a remote communication device network address of the remote communication device and a building control system network address of a network communication module in communication with the building control system, and, upon a positive determination,
send an electronic communication comprising the remote communication device network address to an electronic communication receiving module accessible by the building control system to enable the building control system to obtain the remote communication device network address for reinitiating communications with the remote communication device wherein each of the remote communication device, network communication module and electronic communication receiving module have different network addresses.

2. The remote communication device of claim 1 further arranged to send an indication to the electronic communication receiving module indicating that communications between the remote communication device and the building control system are to be re-initiated.

3. The remote communication device of claim 2, wherein the indication is a flag activation that indicates that communications between the remote communication device and the building control system are to be re-initiated.

4. The remote communication device of claim 2, wherein the remote communication device is further arranged to provide the indication after determining that the network address is different to a previous network address last used to successfully communicate between the remote communication device and building control system.

5. The remote communication device of claim 1, wherein the building control system controller network address is deleted after a predefined period of time.

6. The remote communication device of claim 2, wherein the indication indicates that the remote communication device will be able to communicate with the building control system using the building control system network address when it is received by the electronic communication receiving module.

7. The remote communication device of claim 1, wherein the electronic communication receiving module is a web server and the electronic communication is an HTTP communication.

8. A remote communication method for controlling at least one building control system, the remote communication method comprising the steps of:
determining that there is no communication between a remote communication device network address of the remote communication device and a building control system network address of a network communication module in communication with the building control system, and, upon a positive determination,
sending an electronic communication comprising the remote communication device network address to an electronic communication receiving module accessible by the building control system to enable the building control system to obtain the remote communication device network address for reinitiating communications with the remote communication device wherein each of the remote communication device, network communication module and electronic communication receiving module have different network addresses.

9. The remote communication method of claim 8 further comprising the step of sending an indication to the electronic communication receiving module indicating that communications between the remote communication device and the building control system are to be re-initiated.

10. The remote communication method of claim 9, wherein the indication is a flag activation that indicates that communications between the remote communication device and the building control system are to be re-initiated.

11. The remote communication method of claim 9, further comprising the step of providing the indication after determining that the network address is different to a previous network address last used to successfully communicate between the remote communication device and building control system.

12. The remote communication method of claim 8, wherein the building control system controller network address is deleted after a predefined period of time.

13. The remote communication method of claim 9, wherein the indication indicates that the remote communication device will be able to communicate with the building control system using the building control system network address when it is received by the electronic communication receiving module.

14. The remote communication method of claim 8, wherein the electronic communication receiving module is a web server and the electronic communication is an HTTP communication.
